(19) United States
(12) Patent Application Publication
(10) Pub. No.: US 2015/0272143 A1
(43) Pub. Date: Oct. 1, 2015

(54) METHOD FOR PASTURIZING GROUND POULTRY

(71) Applicant: CARGILL, INCORPORATED, Wayzata, MN (US)

(72) Inventors: Nicole A. Browne, Wichita, KS (US); Oscar Esquivel, Wichita, KS (US)

(21) Appl. No.: 14/438,965

(22) PCT Filed: Oct. 28, 2013
(86) PCT No.: PCT/US2013/067074

§ 371 Date: Apr. 28, 2015

Related U.S. Application Data
(60) Provisional application No. 61/719,569, filed on Oct. 29, 2012.

(51) Int. Cl. A23B 4/12; A23B 4/08

(52) U.S. Cl. CPC A23B 4/12; A23B 4/08; A23V 2002/00

(57) ABSTRACT

Fresh ground poultry meat is preserved by packaging fresh ground poultry meat in a sealed package together with one or more non-synthetic antimicrobials and pressurizing to an elevated pressure of from about 55,000 to about 65,000 psi pressure, maintaining the elevated pressure on the packaged fresh ground poultry meat for a time of from about 3.5 minutes to about 6 minutes and at a temperature of from about 30° to about 45° F. The non-synthetic antimicrobial is present in an amount effective to enhance the effectiveness of the application of the pressure to the packaged fresh ground poultry meat in reducing or eliminating pathogens.

### FIELD OF THE INVENTION

The present invention relates to preservation of ground poultry meat. In particular, the present invention relates to preservation of ground poultry meat by application of pressure and additional ingredients.

### BACKGROUND OF THE INVENTION

Ground meat products are distributed either fresh or frozen. The advantage of using fresh distribution is a perceived consumer acceptance for “fresh” as well as quicker cooking times since one is cooking from fresh (35°-42° F.) instead of frozen (generally 0°-32° F.). However with fresh distribution comes a significantly lesser shelf life compared to frozen distribution (typically 25 days or less versus 120-365 days). Therefore inventory risk (shortages and being long on inventory) is a primary concern of fresh distribution. For example, a grocery store may increase inventory in anticipation of an advertised sale of ground meat for a particular weekend. If a winter storm occurs in the region on that weekend, the store may find itself with excess inventory. The store may need to downgrade the product into a chili or stew to use up the extra inventory at a loss. The opposite circumstance may also occur, when a customer misjudges the demand and is short orders. Due to a limited ability to stockpile inventory because of the traditionally short shelf life of this product, meat processors may not be able to fill the order in time and the customer may not be able to realize the potential margin gain.

Another risk associated with ground meats is the potential contamination by pathogens such as E. coli or Salmonella. If ground meats are undercooked, the potential for pathogens remaining increases and may result in food borne related illnesses.

According to the U.S. Pat. No. 6,033,701, the use of pressure for sterilization of food was discovered early in the 20^{th} century. Early reports of the use of pressure in sterilization focused on fruits. High pressure has been used for treatment of certain foods, such as fish meat and/or kneaded fish meat products as discussed in U.S. Pat. No. 6,440,484 or raw food products, such as raw shellfish as described in U.S. Pat. No. 6,537,601.

U.S. Pat. Nos. 5,593,714 and 6,033,701 describe food product treatment processes where the food product is treated at a pressure of 25,000 psi and a temperature of 18-23 degrees C. for a time period of at least 5 days, or to at least 70 MPa pressure so that said foodstuff or said feedstuff is place under said pressure, maintaining said pressure on said container and said foodstuff or said feedstuff for more than 12 hours at a temperature of between 18 and 23 degrees centigrade, respectively. The very long retention time of these products under pressure as required in these patents is unacceptable for mass production purposes.

Companies such as American Pasteurization Company and Avure Technologies use and/or provide equipment to carry out High Pressure Processing (HPP). These companies are careful to note that they are not food companies, but are equipment suppliers to food producers. Avure Technologies has been granted a number of patents, all focusing on the equipment and the processes for use of the equipment. The American Pasteurization Company currently lists foods that can be processed using HPP as:

Ready-to-eat meat products

Soups & stews

Various fruits & vegetables

Oysters and shellfish

Jams & jellies

Sauces & dips

Cheeses

http://www.amerpastco.com/faq.html

Clearly, HPP is not universally useful for treatment of food products, and process parameters have been developed that are product specific.

In 2001, the US FDA Center for Food Safety and Applied Nutrition published an Evaluation and Definition of Potentially Hazardous Foods that among other strategies discussed the use of HPP for Microbial Inactivation. The report stated:
Ground beef can be pasteurized by HPP to eliminate E. coli O157:H7, Listeria spp., Salmonella spp., or Staphylococcus spp. Much more work is required to develop a suggested hold time at 580 MPa due to the potential for tailing. Changes in product color and appearance may limit the usefulness of HPP treatment pressures above 200 to 300 MPa.
   http://www.cfsan.fda.gov/˜comm/ift4-5.html

Further study of use of HPP in inactivation of various microflora in inoculated ground beef has been carried out since the FDA report. For example, an article entitled “High Pressure Inactivation of Citrobacter freundii, Pseudomonas fluorescens and Listeria innocua in Inoculated Minced Beef Muscle” by A. Carlez et al.; Lebensm.-Wiss. u.-Technol., 26, pp. 357-363 (1993) describes pressure treatment of minced beef under a range of pressures for 20 minute periods at various temperatures. This article notes that the greatest reduction in microorganisms was observed at 50° C. Similarly, an article entitled “High-pressure destruction kinetics of Clostridium sporogenes spores in ground beef at elevated temperatures” by Songming Zhu et al.; International Journal of Food Microbiology, 126 (2008) pp. 86-92, combined high pressure treatment with heat, 80-100° C., to provide effective destruction of spores.

Specific embodiments of high pressure pasteurization of ground meat are described in PCT Application Nos. WO/2011/032837 and WO/2011/03824. These applications note the following advantage:
By use of high pressure, ground meat can advantageously be treated without the use of chemical treatments or incorporation of preservatives that some consumers may find to be objectionable. In an embodiment of the present invention, ground meat products can be prepared using less than half of the amount of preservatives (such as lactates or salt) as compared to like ground meat products that have not been processed using pressure as described herein. In an embodiment of the present invention, the fresh ground meat additionally contains non-endogenous antimicrobial treatment chemicals to further decrease the risk of pathogen contamination of food eaten by the consumer. In an embodiment of the present invention, the fresh ground meat is free of non-endogenous antimicrobial treatment chemicals. In another embodiment of the present invention, the fresh ground meat is free of stabilizers, preservatives and similar processing aids.
   See PCT Application Nos. WO/2011/032837 and WO/2011/03824, both at paragraph [0013].

High pressure pasteurization of whole muscle meat is described in PCT Application No. WO/2011/149900.

The preservation of vegetables in contact with a noble gas, a mixture of noble gases or a mixture containing at least one noble gas is described in U.S. Pat. No. 6,342,261.

### SUMMARY OF THE INVENTION

A process for preserving fresh ground poultry meat is provided comprising the steps of a) packaging fresh ground poultry meat in a sealed package together with one or more non-synthetic antimicrobials; b) placing the packaged fresh ground poultry meat in a pressurization vessel and closing the vessel; c) pressurizing the pressurization vessel containing the packaged fresh ground poultry meat to an elevated pressure of from about 55,000 to about 65,000 psi pressure so that the packaged fresh ground poultry meat is placed under the elevated pressure; d) maintaining the elevated pressure on the packaged fresh ground poultry meat for a time of from about 3.5 minutes to about 6 minutes and at a temperature of from about 30° to about 45° F.; e) then reducing the pressure on the packaged fresh ground poultry meat to ambient pressure; and f) removing the packaged fresh ground poultry meat from the pressurization vessel. The non-synthetic antimicrobial is present in an amount effective to enhance the effectiveness of the application of pressure to the packaged fresh ground poultry meat in reducing or eliminating pathogens from the meat.

The present invention provides an advantage in preservation of ground poultry meat products by efficiently killing pathogens in the meat and decreasing the risk of pathogen contamination of food eaten by the consumer using a method that is physically more gentle with respect to the ground meat than higher pressure treatments, and that is more acceptable from a consumer preference perspective because it uses non-synthetic antimicrobials. It has surprisingly been found that the non-synthetic antimicrobial acts, when provided in a sufficient amount, to enhance the effectiveness of the application of pressure to the packaged fresh ground poultry meat in reducing or eliminating pathogens from the meat. Thus, the effectiveness of the combination of application of pressure as described herein with the use of non-synthetic antimicrobials in reducing or eliminating pathogens from the meat is higher than the expected additive antimicrobial effect of each of these measures when carried out separately.

In another aspect, spoilage organisms introduce off odors and flavors in meat even before they are unhealthy for consumption. The present invention can improve the length of time that a meat product is at high quality as compared to prior art processes.

Additionally, the present process is surprisingly effective at reducing or eliminating pathogens even though the meat is not at elevated temperature. Thus, pathogens can be effectively killed in ground poultry meat while at the same time maintaining preferred processing conditions whereby the ground poultry meat never exceeds the temperature of 45° F. This allows meat producers to establish an HACCP program using well recognized safe temperature handling protocols without the need to heat the meat. The present invention thus provides a process whereby meat can be processed without transitioning the meat through undesirable temperature ranges (i.e. above conventional refrigeration temperatures and below cooking temperatures).

Finally, the present process surprisingly is capable of providing ground poultry meat products that exhibit superior hedonic scores in one or more measurable aspects as compared to ground poultry meet products provided by alternative techniques. Superior hedonic scores may be observed in one or more areas, including raw odor, texture, juiciness, overall flavor, and overall acceptability.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a graph showing a time/pressure treatment profile of an embodiment of the present method.

FIG. 2 is a graph showing a time/pressure treatment profile of another embodiment of the present method.

FIG. 3 is a graph showing a time/pressure treatment profile of another embodiment of the present method.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As a first step in the process of the present invention, fresh ground poultry meat is packaged in a sealed package together with one or more antimicrobials

The fresh ground poultry meat to be treated in accordance with the present invention may be any variety of ground poultry meat. Poultry may include, but are not limited to, chicken, turkey, and ostrich. In a preferred embodiment, the poultry is turkey.

The ground poultry meat may comprise boneless or ground poultry meat generated from soft tissue portions of bone-in parts, or a mixture of both. For purposes of the present invention “boneless poultry meat” is meat that can be obtained by ready separation from bone and/or connective tissue (e.g. cartilage and tendon) portions of the carcass by cutting or use of a “puncher” devices. In the embodiment where the meat is removed by a “puncher device,” the meat is separated from bones and/or connective tissue by driving the non-soft portions from the meat using a driving or punching tool. Examples of meat portions that serve as the source of boneless meats include breasts, thighs and drums.

For purposes of the present invention, “ground poultry meat generated from soft tissue portions of bone-in parts” is meat derived from portions of the poultry that is in close proximity to bone that cannot be separated by use of cutting or “puncher’ devices, but wherein the hard tissue portions are removed from the soft tissue portions, e.g. by a mechanical screen separator device, such as those available from Poss Design Limited of Toronto, Canada.

In general, boneless meat is a high value product because it provides a carvable boneless cut for ease of preparation and consumption by the consumer. For example, turkey breast is a high value product for sale as a whole meat portion, and is not generally used for ground turkey products. At the same time, bone-in meat is considered to be very appropriate for use in ground products, not only because this is a format that makes the protein more conveniently available to the consumer, but because the meat is particularly flavorful due to its close proximity to the bone. Soft tissue portions could be generated from bone-in parts including wings, back portions, necks, and parts with broken bones.

The meat is ground in a conventional manner. In most large scale processing systems, the meat is first ground to ½ inch diameter portions, and the fat content of the meat is adjusted to meet product requirements. The meat then typically is ground again to provide ⅛ to 3/32 “noodles.”

The non-synthetic antimicrobial used in the present invention may be any food-safe non-synthetic antimicrobial that may be consumed in the end product. For purposes of the present invention, a non-synthetic antimicrobial is an antimicrobial having a chemical constitution that is not chemically synthesized to form molecules not otherwise found in nature. Such non-synthetic or “natural” antimicrobials are particularly advantageous because they are “label-friendly,” because they satisfy the growing desire of consumers to simplify the foods they eat and to reduce their intake of ingredients that they perceive to be undesirable “chemicals.” Surprisingly, such label friendly antimicrobials additionally are highly effective when used in combination with the pressure treatment as described herein.

The non-synthetic antimicrobial used in the present invention may be present in any amount effective to impart an antimicrobial effect, and preferably in an amount less than the amount that will impart undesirable flavors to the ground poultry meat. In an embodiment, the antimicrobial is present in the ground poultry meat in from about 0.1 to about 1.5% wt. In another embodiment, the antimicrobial is present in the ground poultry meat in from about 0.3 to about 1% wt.

In a preferred embodiment, the antimicrobial is an organic acid. Examples of such organic acids include vinegar, lemon juice, lime juice, and combinations

In another preferred embodiment, the antimicrobial is a natural metabolite produced by fermenting food grade cultures of dairy- and/or sugar-based ingredients. Examples of such natural metabolites include cultured dextrose, cultured skim milk, or cultured corn syrup solids. Such fermentate-based antimicrobials are commercially available as MicroGARD™ products from Dupont® Company, DuraFresh™ products from Kerry™ Bio-Science Company, or PuraQ Verdad™ NV 10/NV 15 from Purac™ Company.

In a preferred embodiment, the antimicrobial is an extract of one or more spices. Examples of sources of such extracts include pepper, thyme, oregano, mint, pomegranate, rosemary, and exotic cherries.

The use of certain antimicrobials, even within the category of “natural” antimicrobials, additionally may limit the name of a ground meat product permitted due to government regulation. For example ground turkey may be required to be called by another name simply because an added antimicrobial is in liquid form, even though the antimicrobial is “natural.” It surprisingly has been discovered that dry antimicrobial ingredients may be highly effective when used in the context of the present process, which provides advantage not only in antimicrobial functionality, but also in label presentation to consumers as a natural product even in the face of strict labeling requirements.

In an embodiment of the present invention, the fresh ground poultry meat contains additional food inclusions. For example, the food inclusions may be selected from mushrooms, onions, garlic, cheeses and combinations thereof. In another embodiment, the ground poultry meat contains seasoning inclusions. This is particularly advantageous because such a combination product provides consumers with the convenience they demand. Further, it is exceptionally difficult to provide combination products on a large commercial scale because spoilage is accelerated when such products are stored in combination.

In an embodiment of the present invention, the fresh ground poultry meat contains spices and/or seasonings in an amount effective to noticeably improve the odor of the meat after exposure to pressure. In a preferred embodiment, the spices and/or seasonings are in an amount effective to noticeably improve the odor of the meat after exposure to pressure but to not noticeably alter the flavor of the meat as compared to like meat that has not been exposed to pressure elevated over ambient pressure. Flavor and odor evaluations are carried out by untrained panels as is routinely carried out by skilled artisans in the food industry.

The meat is divided into appropriate portions and packaged in a sealed package. In an embodiment of the invention, the packaged fresh ground poultry meat is in a meat portion (i.e. total amount of meat in the package) of from about ⅛ to about 25 pounds of meat, and in another embodiment in a meat portion of from about ⅛ to about 5 pounds of meat. Thus, the meat may be sized for use by institutional customers (e.g. restaurant, food service, or commercial users) or for the home consumer. The meat may be provided in any format, such as in the form of patties, pre-formed meat loaves, stuffed food products such as stuffed peppers, and the like.

The package is an air-tight package suitable for storage, transport and presentation to the consumer. The packaging may be of a bulk, shipping, or individual serving type; wherein the container is a formable pouch, injectable pouch, sealable pouch, formable tray, vacuum formable tray or pouch, heat formable tray or pouch, or film covered tray. In an embodiment, the sealed package comprises a tray and has headspace over the fresh ground poultry meat. Preferably, the fresh ground poultry meat is packaged in a sealed package having an oxygen displaced gas environment, meaning that the amount of oxygen in the package is at least less than present in the common atmosphere, and preferably substantially less than is present in the common atmosphere. Reduction in the exposure of the ground poultry meat to oxygen is advantageous, because this reduces oxidation of the meat. Preferably the gas environment within the meat packaging is purged of oxygen. In an embodiment, the gas environment comprises a gas selected from carbon dioxide, nitrogen, carbon monoxide, nitrous oxide, hydrogen, neon, argon, krypton, xenon and mixtures thereof.

Ground poultry meat is preferably subjected to a gaseous atmosphere as discussed above by flushing, injecting, sparging, applying a vacuum and then flushing, pressurizing, or introducing said gaseous atmosphere into an impermeable or semipermeable film covering the ground poultry meat.

The packaged fresh ground poultry meat may then be placed in a pressurization vessel and pressure may be applied in any appropriate manner. Equipment used to treat materials using high pressure is described, for example, in U.S. Pat. Nos. 7,220,381; 5,316,745; 5,370,043; 7,310,990; and 7,096,774.

A preferred process comprises submerging the packaged fresh ground poultry meat in a liquid (often water) within an enclosed vessel. Pressure is then generated either by pumping more liquid into the pressure vessel or by reducing the volume of the pressure chamber. This pressure is uniformly distributed over all materials in the vessel, and even packages with headspace do not ordinarily burst.

The pressurization vessel containing the packaged fresh ground poultry meat is pressurized to an elevated pressure of from about 55,000 to about 65,000 psi pressure so that the packaged fresh ground poultry meat is placed under the elevated pressure.

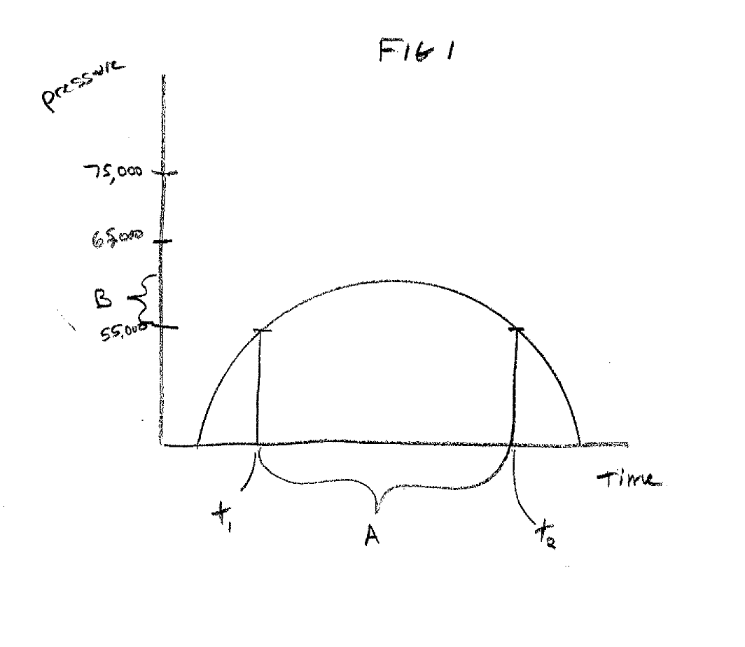

FIG. 1 is a graph showing a time/pressure treatment profile of an embodiment of the present method, wherein the pressurization of the meat has a time/pressure profile that is generally a bell curve, i.e. having a increase in pressure over time followed by a decrease in pressure over time. As may be seen in FIG. 1, pressure increases over time to reach t₁, which is the point at which the pressure is 55,000 psi. Pressure continues to increase, and then decreases until time t₂, when the pressure is again at 55,000 psi. During the time interval A, the pressure is always within the range B, which is within the identified pressure range of 55,000 to 65,000 psi.

In an embodiment of the present invention, the elevated pressure is from about 57,000 psi to about 63,000 psi.

The elevated pressure is maintained on the packaged fresh ground poultry meat for a time of from about 3.5 minutes to about 6 minutes. In an embodiment of the present invention, the packaged fresh ground poultry meat is under elevated pressure for a time of from about 3.5 minutes to about 5 minutes. In an embodiment of the present invention, the packaged fresh ground poultry meat is under elevated pressure for a time of from 3.5 minutes to about 4.5 minutes.

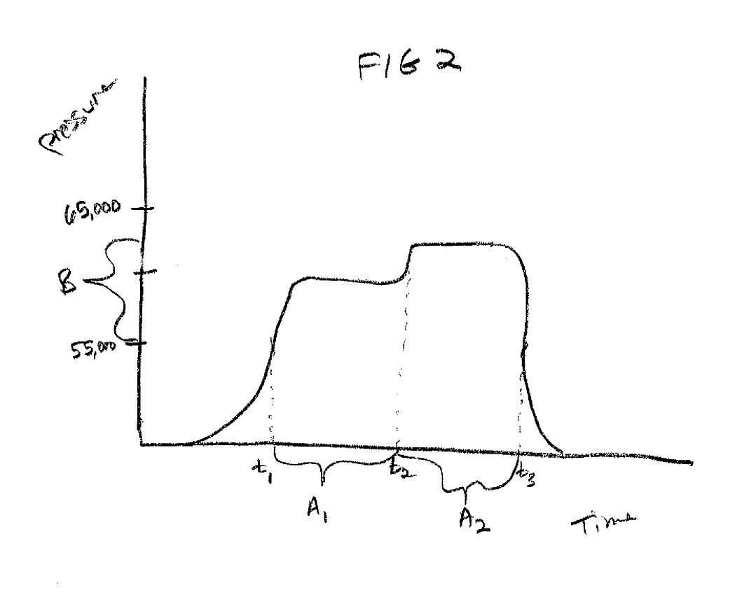

FIG. 2 is a graph showing a time/pressure treatment profile of another embodiment of the present method wherein the packaged fresh ground poultry meat is maintained under elevated pressure that is at least two distinct pressures. As may be seen in FIG. 2, pressure increases over time to reach t1, which is the point at which the pressure is 55,000 psi. Pressure is increased and then maintained at a generally constant pressure between 55,000 psi and 65,000 psi until time t₂, when the pressure is increased and maintained at another generally constant pressure between 55,000 psi and 65,000 psi. The pressure is then allowed to decrease until time t₃, when the pressure is again at 55,000 psi. During the time intervals A₁ and A₂, the pressure is always within the range B, which is within the identified pressure range of 55,000 to 65,000 psi.

The time intervals A₁ and A₂ together add up to the about 3.5 minutes to about 6 minutes time period.

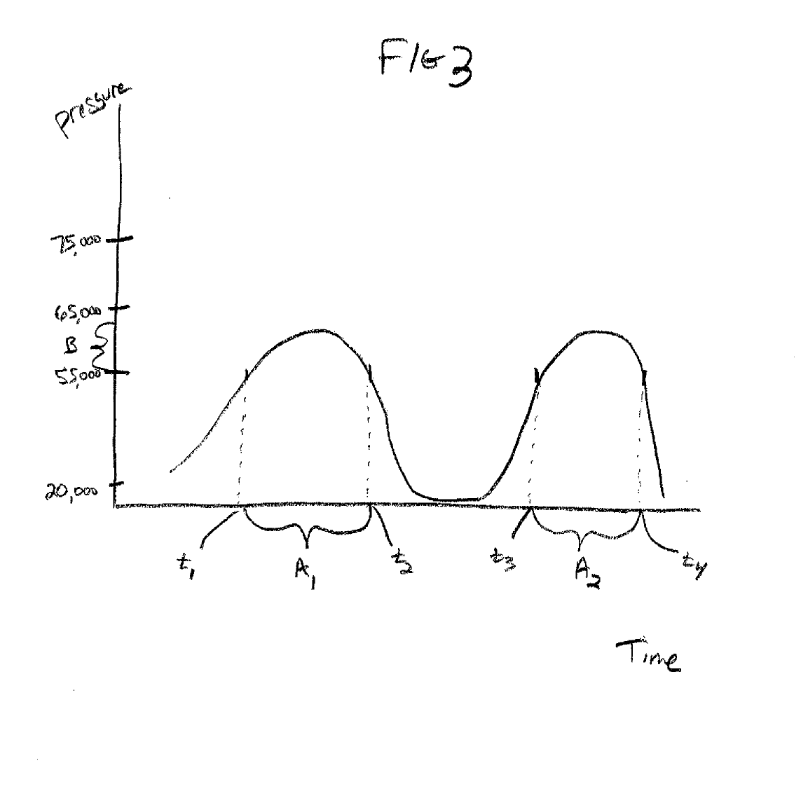

FIG. 3 is a graph showing a time/pressure treatment profile of another embodiment of the present method wherein the packaged fresh ground poultry meat is cycled through at least two cycles of pressurizing to about 55,000 to about 65,000 psi for a time of from about 3.5 minutes to about 6 minutes for each cycle, and the pressure on the packaged fresh ground poultry meat is reduced to a pressure less than about 55,000, and preferably less than about 20,000 psi between pressurization cycles.

As may be seen in FIG. 3, pressure increases over time to reach t₁, which is the point at which the pressure is 55,000 psi. Pressure continues to increase, and then decreases until time t₂, when the pressure is again at 55,000 psi. During the time interval A₁, the pressure is always within the range B, which is within the identified pressure range of 55,000 to 65,000 psi. The pressure is then allowed to decrease to a pressure preferably less than about 20,000 psi. The pressure is then allowed to increase over time to reach t₃, which is the point at which the pressure is again at 55,000 psi. Pressure continues to increase, and then decreases until time t₄, when the pressure is again at 55,000 psi. During the time interval A₂, the pressure is always within the range B, which is within the identified pressure range of 55,000 to 65,000 psi. The time duration of the low intermediate pressure interval (i.e. the time between time t₂ and t₃) may be any desired time, but preferably is from about 1 second to about 1 minute. The time intervals A₁ and A₂ are each individually from about 3.5 minutes to about 6 minutes time period.

In an embodiment of the present invention, at least two cycles take place in the same pressurization vessel. In an embodiment of the present invention, at least two cycles take place in different pressurization vessels.

After completion of the pressurization steps, the pressure on the packaged fresh ground poultry meat is reduced to ambient pressure and the packaged fresh ground poultry meat is removed from the pressurization vessel. For purposes of the present invention, “ambient pressure” is the pressure of the environment or surrounding area at the processing location.

The pressurization is carried out at a temperature of from about 30° F. to about 50° F. Preferably, the temperature of the fresh ground poultry meat is never above about 45° F., and more preferably never above about 40° F. during the entire production process from the grinding step through to removal of the ground poultry meat from the pressurization vessel. Preferably, the meat is at a temperature that is sufficiently high so that liquid is present in the meat, i.e. the meat is not frozen. It has been found that the antimicrobial effect of high pressure is much better when the meat is not frozen.

Optionally, the entire process is carried out with the ground poultry meat at a temperature of from about 30° F. to about 45° F., and then the meat is frozen for storage and/or distribution.

Because the fresh ground poultry meat product is already in a sealed package before treatment, the meat is not touched again or exposed to the air or unsanitary conditions until the package is opened by the consumer.

In a preferred embodiment of the present invention, the packaged fresh ground poultry meat is submerged in water during the pressure treatment step. If the packaging is faulty, the present pressure treatment advantageously exposes any packaging defects such as pinholes, usually by permitting a detectable amount of water to enter into the package. Thus the present invention beneficially operates to reveal defective packaging that would lead to premature product spoilage if not detected.

In use, the packaged fresh ground poultry meat is sold in distribution channels in the packages in which the meat was treated, ready for customer purchase. This provides significant advantages, in that the package remains sealed until the ultimate customer (e.g. restaurant, food service or home consumer) opens the package and uses the ground poultry meat for the desired purpose.

### EXAMPLES

Representative embodiments of the present invention will now be described with reference to the following examples that illustrate the principles and practice of the present invention.

### Example 1

This example demonstrates the incidence of Salmonella in ground turkey without pressure treatment, with pressure treatment, and with both antimicrobial and pressure treatment.

Independent batches of ground turkey, with and without antimicrobial, were blended and prepared following normal production procedures. The ground turkey was packaged, and ten packages of each treatment were tested for Salmonella incidence. Ground turkey samples, excluding controls, were exposed to 87,000 psi pressure for 3 minutes. 24 hours after processing, ten packages of each treatment, including controls, were tested for Salmonella incidence. The ground turkey maintained a temperature between 30-38° F. throughout processing.

The control ground turkey product was not treated with pressure, and had no added antimicrobial.

Ground turkey samples treated with antimicrobial was provided with vinegar or organic acids at 10.0 mg/g.

The Salmonella incidence in samples was evaluated by the BAX method, and the results are reported in Table 1.

TABLE 1
Salmonella incidence by ingredient treatment and HPP cycle

| | Mean Percentage Incidence* |
|---|---|
| No added antimicrobial | |
| No HPP | 80.00 |
| HPP with dwell time 3 min | 20.00 |
| With antimicrobial | |
| HPP with dwell time 3 min | 6.67 |

As shown in Table 1, control samples exhibited a Salmonella incidence of 80% in ground poultry meat. Samples that were processed using high pressure and additionally comprising an added antimicrobial reduced Salmonella incidence to 6.67%. Samples processed using high pressure, but having no added antimicrobial only reduced Salmonella incidence to 20%.

### Example 2

This example demonstrates the reduction of incidence of Salmonella in ground turkey that has been treated with pressure, and ground turkey that has been treated with both antimicrobial and pressure.

Samples were prepared as described above in Example 1, except using different antimicrobial combinations. The control ground turkey product was treated with pressure, and had no added antimicrobial. Additional ground turkey samples were treated with a combination of Microgard™ 200, a commercially available byproduct of fermentation, and liquid vinegar (“MVG”) or a combination of Microgard™ 200 and dry vinegar (“DVMG”) antimicrobial The amounts of these materials used were: Microgard™ 200—6.0 mg/g; Liquid Vinegar—7.5 mg/g; and Dry Vinegar—3.0 mg/g.

Salmonella incidence in the samples was evaluated by the test method described in Example 1, and the results are reported in Table 2 as reduction of incidence data.

TABLE 2
% Reduction in Salmonella Incidence

| Ingredient Treatment | Mean Percentage Reduction |
|---|---|
| none | 85.9 |
| MVG | 100 |
| DVMG | 96.7 |

As shown in Table 2, pressure treated samples having no added antimicrobial ingredients reduced Salmonella incidence in ground poultry meat by 85.9%, but pressure treated samples having added organic acids and by-products of fermentation reduced Salmonella incidence in ground poultry meat by 96.7% and 100%, respectively.

### Example 3

This example demonstrates the hedonics of ground turkey that has been treated by application of pressure at two different pressure levels.

Samples were prepared as described above in Example 1. Ground turkey samples treated with pressure (HPP) were packaged and exposed to pressure at 60,000 psi for 3.5 minutes, or at 87,000 psi for 3 minutes.

The samples were evaluated by an untrained panel of human testers to evaluate the organoleptic characteristics of the product as would be perceived by the average consumer.

Specifically, treated product was maintained at a temperature of between 30-38° F. in a sealed package. The package was opened, and the tester evaluated the raw odor of the product within 60-120 seconds of opening, and rated their impressions of the odor on a 9-point hedonics scale (1 dislike extremely, 2 dislike very much, 3 dislike moderately, 4 dislike slightly, 5 neither like nor dislike, 6 slightly like, 7 like moderately, 8 like very much, 9 like extremely).

Approximately 3 pounds of product from each HPP pressure was formed into patties and cooked until internal temperature reached 165° F. on a flattop griddle. The cooked patties were cut into quarters, and the cooked product was evaluated for flavor, texture and juiciness, overall flavor and overall acceptability using a 9-point structured hedonic scale and just about right (“JAR”) scales for juiciness (not juicy enough to too juicy), texture (too tender to too rubbery), and flavor (not strong enough to too strong).

The results of the hedonic testing are reported in Table 3.

TABLE 3
Sensory analysis of ground seasoned turkey

| | 60,000 psi/3.5 min | 87,000 psi/3 min |
|---|---|---|
| JAR Percentage | | |
| Flavor | 93.3 | 57.8 |
| Texture | 60.0 | 57.8 |
| Juiciness | 86.7 | 64.4 |
| Hedonic Score | | |
| Raw Odor | 6.10 | 6.03 |
| Texture | 6.58 | 6.44 |
| Juiciness | 7.56 | 6.78 |
| Overall Flavor | 7.51 | 6.53 |
| Overall Acceptability | 7.36 | 6.73 |

The hedonic scores for raw odor and texture for the two samples were not statistically different in this test. The hedonic scores for juiciness, overall flavor and overall acceptability for the two samples were statistically different in this test.

As shown in Table 3, ground turkey meat samples that underwent pressure treatment at a lower pressure has significantly higher sensory scores in juiciness, flavor, and consumer acceptability than ground turkey meat samples that underwent pressure treatment at a higher pressure of 87,000 psi.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A process for preserving fresh ground poultry meat comprising the steps of:
a) packaging fresh ground poultry meat in a sealed package together with one or more non-synthetic antimicrobial;
b) placing the packaged fresh ground poultry meat in a pressurization vessel and closing the vessel;
c) pressurizing the pressurization vessel containing the packaged fresh ground poultry meat to an elevated pressure of from about 55,000 to about 65,000 psi pressure so that the packaged fresh ground poultry meat is placed under the elevated pressure;
d) maintaining the elevated pressure on the packaged fresh ground poultry meat for a time of from about 3.5 minutes to about 6 minutes and at a temperature of from about 30° to about 50° F.;
e) then reducing the pressure on the packaged fresh ground poultry meat to ambient pressure; and
f) removing the packaged fresh ground poultry meat from the pressurization vessel;
wherein the non-synthetic antimicrobial is present in an amount effective to enhance the effectiveness of the application of pressure to the packaged fresh ground poultry meat in reducing or eliminating pathogens from the meat.

2. The process of claim 1, wherein the elevated pressure is from about 57,000 psi to about 63,000 psi.

3. The process of any of claims 1-2, wherein the packaged fresh ground poultry meat is under elevated pressure for a time of from about 3.5 minutes to about 5 minutes.

4. The process of any of claims 1-2, wherein the packaged fresh ground poultry meat is under elevated pressure for a time of from about 3.5 minutes to about 4.5 minutes.

5. The process of any of claims 1-4, wherein the fresh ground poultry meat is in the form of patties.

6. The process of any of claims 1-5, wherein the packaged fresh ground poultry meat comprises ground poultry meat generated from soft tissue portions of bone-in parts.

7. The process of any of claims 1-5, wherein the packaged fresh ground poultry meat comprises turkey.

8. The process of any of claims 1-6, wherein the maintaining step d) comprises maintaining the packaged fresh ground poultry meat at at least two distinct pressures during the 3.5 minutes to about 6 minutes time period.

9. The process of any of claims 1-7, comprising cycling the packaged fresh ground poultry meat through at least two cycles of pressurizing to about 55,000 to about 65,000 psi for a time of from about 3.5 minutes to about 6 minutes for each cycle and reducing the pressure on the packaged fresh ground poultry meat to a pressure less than about 55,000 psi between pressurization cycles.

10. The process of claim 9, wherein at as two pressurization cycles take place in the same pressurization vessel.

11. The process of claim 9, wherein at least two pressurization cycles take place in different pressurization vessels.

12. The process of any of claims 1-11, wherein the antimicrobial is a byproduct of a fermentation product.

13. The process of any of claims 1-11, wherein the antimicrobial is an organic acid.

14. The process of any of claims 1-11, wherein the antimicrobial is an extract of a spice.

15. The process of any of claims 1-14, wherein the antimicrobial is a thy ingredient.

16. The process of any of claims 1-15, wherein the fresh ground poultry meat is additionally frozen for storage and delivery to a customer.
